(19) United States
(12) Patent Application Publication
(10) Pub. No.: US 2003/0110811 A1
(43) Pub. Date: Jun. 19, 2003

(54) Single mode optical fiber and manufacturing method therefor

(75) Inventors: Tomohiro Nunome, Sakura-shi (JP); Hiroshi Kutami, Sakura-shi (JP); Manabu Saitou, Sakura-shi (JP); Kenji Okada, Sakura-shi (JP); Munehisa Fujimaki, Sakura-shi (JP); Koichi Harada, Sakura-shi (JP)

Correspondence Address: HOFFMANN & BARON, LLP, 6900 JERICHO TURNPIKE, SYOSSET, NY, 11791, US

(73) Assignee: SINGLE MODE OPTICAL FIBER AND MANUFACTURING METHOD THEREFOR

(21) Appl. No.: 10/304,844

(22) Filed: Nov. 26, 2002

(30) Foreign Application Priority Data
Nov. 29, 2001 (JP) 2001-365172

(51) Int. Cl. C03B 37/025

(52) U.S. Cl. 65/421; 65/424; 65/435; 65/507; 65/509

(57) ABSTRACT

An optical fiber is formed by performing vapor phase deposition of SiO₂ on the outside of a glass rod comprising a core section and a first cladding section and drawing a glass preform which formed by a second cladding section. Also, a single mode optical fiber is manufactured so that the ratio of the diameter D of the first cladding section and the diameter d of the core section is in a range of 4.0 to 4.8, and OH concentration is 0.1 ppm or less. Also, an optical fiber is manufactured so that a value of D/d>4.8, and the OH concentration is 0.1 ppm or less. It is thereby possible to maintain an initial loss in the 1380 nm wavelength range even if hydrogen diffusion occurs.

### BACKGROUND OF THE INVENTION

1. Field of the Invention

The present invention relates to a manufacturing method for a single mode optical fiber for optical communications. In particular, the present invention relates to a manufacturing method for a single mode optical fiber which has a low loss in the 1380 nm wavelength range and superior hydrogen resistance.

2. Description of Related Art

As the amount of data traffic increases, technology has improved in the area of wavelength division multiplexing transmission systems. For increasing the transmission capacity, it is important to broaden the available wavelength range. Currently, the C-Band or L-Band are used as such a wavelength range which can be amplified by an erbium-doped optical fiber. As a form for realizing a broader wavelength range, a thulium-doped optical fiber in which amplification can be performed in the S-Band and a Raman amplifier in which amplification can be performed at any wavelength are under development. As a result, it is possible to perform amplification in all ranges of low loss regions in optical fibers; thus, it is necessary to obtain an optical fiber having a low loss region in all wavelength ranges.

An optical fiber has a low loss region in the 1200 to 1600 nm wavelength and a large loss peak in the 1380 nm wavelength range due to the existence of hydroxyl-ion (OH). The loss peak is caused by the material which forms an optical fiber. An optical fiber is made from a silica glass which has a network structure in which SiO₂ is united randomly in a three-dimensional manner. When impurities or defects exist in the network structure, new bonding and breakage occur; thus, these factors cause optical absorptions. Among such optical absorptions, it is estimated that the loss at 1380 nm wavelength may be caused by hydroxyl-ion (OH) existing in the silica glass. Therefore, the greater the amount of hydroxyl-ion (OH) included therein, the larger the loss that will occur at 1380 nm wavelength.

Because the loss peak is broad, wavelength ranges on both sides of the loss peak cannot be used for optical communications. From a practical point of view, it is possible to perform optical communications in a broad wavelength range if the loss in 1380 nm wavelength range can be under 0.31 dB/km.

In Japanese Unexamined Patent Application, First Publication No. Hei 11-171575, it is disclosed that the loss in 1380 nm wavelength range caused by the existence of the OH can be reduced by controlling the value of the diameter of the core/clad ratio (D/d ratio) within a certain range.

It is possible to manufacture an optical fiber having a lower loss at 1380 nm than 0.33 dB/km by using a method which is disclosed in Japanese Unexamined Patent application, First Publication No. Hei 11-171575. This method relates to a manufacturing method for a cladding using a jacket made of a silica glass tube, and an advantage of the method is reducing the manufacturing cost by using a jacket made of a silica glass tube. However, there was a problem in that bubbles tend to remain between the core rod and the silica glass tube.

Also, the quality of the optical fibers depends on factors such as OH concentration or bending of the silica glass tube; therefore, there was a problem in that extreme quality control was always necessary. As a result, product yield decreased; thus the manufacturing cost increased. Also, even when an initial loss in 1380 nm wavelength range was low, there was a problem in that the loss increased due to hydrogen which diffused from the outside. However, there has not been an available countermeasure for such phenomenon.

### SUMMARY OF THE INVENTION

The present invention was made in consideration of the above-mentioned problems. An object of the present invention is to provide a manufacturing method for a single mode optical fiber which has a lower initial loss at 1380 nm wavelength range and can maintain the loss at 1380 nm wavelength range at a lower level than in a conventional optical fiber even when hydrogen diffuses from the outside.

In order to solve the above-mentioned problems, in a first aspect of the present invention, a manufacturing method for a single mode optical fiber is characterized in comprising a step in which a glass rod having a core section in which the refractive index is higher and a first cladding section in which the refractive index is lower than the core section is manufactured; a step in which vapor phase deposition for a second cladding section such as SiO₂ particle is performed around an outer circumference of the glass rod and the glass rod is sintered so as to manufacture a glass preform; and a step in which a drawing operation is performed on the glass preform so as to manufacture an optical fiber; wherein a value of D/d such as a ratio of diameter D of the first cladding section and diameter d of the core section is in a range of 4.0 to 4.8; OH concentration of the core section, the first cladding section, and the second cladding section is 0.1 ppm or less.

By doing this, it is possible to reduce more bubbles in an interface between the core and the cladding, or between the first cladding section and the second cladding section than a case in which a silica glass tube is used for a jacket. It is easy to dehydrate the porous soot to which vapor phase deposition is performed; therefore, it is possible to control OH concentration desirably. Also, a silica glass tube is not used, there is no problem such as bending of a core rod and a cladding made of a silica glass tube; therefore, product yield increases. Accordingly, it is possible to produce a single mode optical fiber at low manufacturing cost.

In a second aspect of the present invention, a manufacturing method for a single mode optical fiber is characterized in comprising: a step in which a glass rod having a core section in which the refractive index is higher and a first cladding section in which the refractive index is lower than the core section is manufactured; a step in which vapor phase deposition for a second cladding section such as SiO₂ particle is performed around an outer circumference of the glass rod and the glass rod is sintered so as to manufacture a glass preform; and a step in which a drawing operation is performed on the glass preform so as to manufacture an optical fiber; wherein a value of D/d such as a ratio of the diameter of the first cladding section and a diameter of the core section is D/d>4.8; OH concentration of the core section and the first cladding section are 0.1 ppm or less; and OH concentration of the second cladding section is 100 ppm or less.

In a third aspect of a manufacturing method for a single mode optical fiber, the fiber has an initial loss in the 1380 nm wavelength range is 0.31 dB/km or less; and loss in the 1380 nm wavelength range after hydrogen diffusion is 0.35 dB/km.

By doing this, the peak in the 1380 nm wavelength range becomes small, and both sides of the wavelength range can be used for optical communications. Also, because it is possible to maintain a loss under 0.35 dB/km in the 1380 nm wavelength range after hydrogen diffuses, it is possible to supply a single mode optical fiber in which the loss in the 1380 nm wavelength range is low when hydrogen diffusion occurs at low manufacturing cost.

In a fourth aspect of the manufacturing method for a single mode optical fiber, in a drawing process, the drawing operation is performed on the glass preform by using a drawing device having an annealing unit so as to manufacture an optical fiber.

By doing this, it is possible to maintain an occurrence of SiO. at low level. Therefore, it is possible to manufacture a single mode optical fiber in which the loss does not increase in the 1380 nm wavelength range even if hydrogen diffuses from the outside of the optical fiber so as to be durable over long periods.

In a fifth aspect of the manufacturing method for a single mode optical fiber, the annealing unit comprises a furnace with inclined heat zone and an annealing tube.

In a sixth aspect of the manufacturing method for a single mode optical fiber, in the annealing unit, the annealing atmosphere is any one of an air, Ar, N₂, or mixture thereof.

In a seventh aspect of the present invention, a single mode optical fiber is manufactured by a manufacturing method according to any one of first to sixth aspects of the present invention.

As explained above, according to the present invention, by forming a glass preform by performing vapor phase deposition of SiO₂ which forms a second cladding section around the outside of an outer circumference of a glass rod comprising a core section and a first cladding section, an optical fiber can be produced by performing drawing of the glass preform. Therefore, it is possible to reduce the occurrence of bubbles to a greater extent in an interface between a core and a clad or between a first cladding section and a second cladding section as comparing the case in which a silica glass tube is used for a jacket. Also, because it is easy to dehydrate a porous soot on which vapor phase deposition is to be performed, it is possible to produce an optical fiber by controlling its OH concentration desirably. Also, because a silica glass tube is not used, there is no problem such as bending of a core rod and a silica glass tube which forms a cladding. Therefore, it is possible to increase product yield; thus, it is possible to manufacture a single mode optical fiber at low manufacturing cost.

Also, an optical fiber is manufactured so that a value of D/d such as a ratio of the diameter D of the first cladding section and the diameter d of the core section is in a range of 4.0 to 4.8, and the OH concentration of the core section, the first cladding section, and the second cladding section is 0.1 ppm or less, a value of D/d such as a ratio of the diameter of the first cladding section and the diameter of the core section is D/d>4.8, the OH concentration of the core section and the first cladding section are 0.1 ppm or less, and the OH concentration of the second cladding section is 100 ppm or less. Therefore, it is possible to maintain an initial loss in the 1380 nm wavelength range under 0.31 dB/km. Also, because the peak in 1380 nm wavelength range becomes small, it is possible to use both sides of the peak for optical communications.

Also, because it is possible to restrict a loss in the 1380 nm wavelength range after hydrogen diffusion to under 0.35 dB/km, it is possible to supply a single mode optical fiber having a low loss in the 1380 nm wavelength range even if hydrogen diffusion occurs at a low manufacturing cost.

Also, in a step of drawing, by performing a drawing operation using a drawing apparatus having an annealing device, it is possible to restrict generation of SiO.to low level. Therefore, there is a little loss increase due to hydrogen in the 1380 nm wavelength range even if hydrogen diffuses from the outside of the optical fiber; thus, it is possible to produce a single mode optical fiber which is durable over a long period.

Also, an initial loss of a single mode optical fiber which is produced by an above-mentioned manufacturing method is under 0.31 dB/km in the 1380 nm wavelength range, and the peak in the 1380 nm wavelength range can be small. Therefore, it is possible to use both sides of the wavelength range for optical communications. Also, because it is possible to restrict a loss in the 1380 nm wavelength range after hydrogen diffusion to under 0.35 dB/km, it is possible to perform optical communications in 1380 nm wavelength range with a low loss even if hydrogen diffusion occurs.

### BRIEF DESCRIPTION OF THE DRAWING

FIG. 1 is a cross section of a glass preform for producing a single mode optical fiber according to the present invention.

FIG. 2 is a view showing an example of a drawing apparatus which is used in a manufacturing method of a single mode optical fiber according to the present invention.

FIG. 3 is a view showing another example of a drawing apparatus which is used in a manufacturing method of a single mode optical fiber according to the present invention.

FIG. 4 is a view showing an example of a conventional drawing apparatus.

### DETAILED DESCRIPTION OF THE INVENTION

The present invention is explained with reference to the drawings as follows.

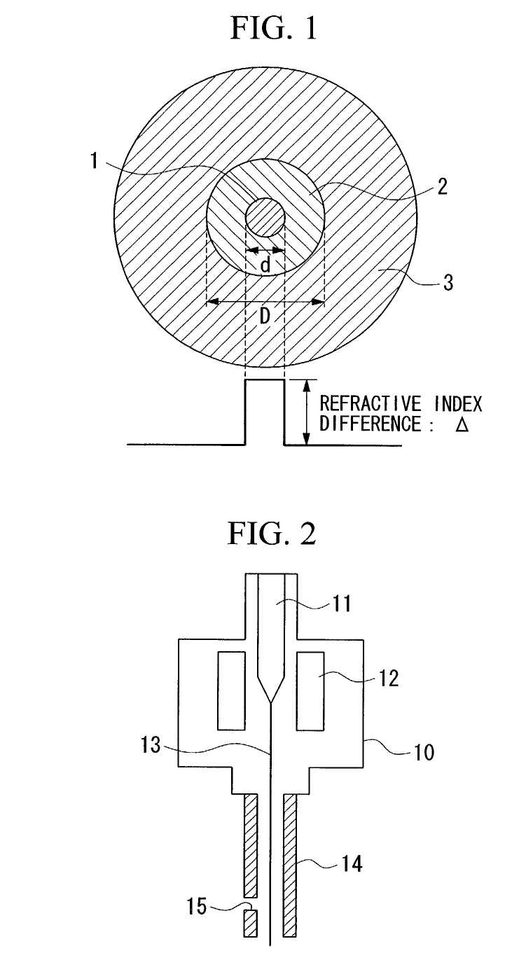

FIG. 1 is a cross section of a glass preform for producing a single mode optical fiber according to the present invention.

In FIG. 1, reference numeral 1 indicates a core section having a high refractive index. Reference numeral 2 indicates a first cladding section which is disposed around an outer circumference of the core section 1 and has a lower refractive index than that of the core section 1. Reference numeral 3 indicates a second cladding section having the same refractive index as that of the first cladding section 2.

A manufacturing method for a glass preform and an optical fiber which is formed by performing drawing of the glass preform is explained as follows.

First, a porous soot having a core section 1 having a high refractive index and a first cladding section having a refractive index lower than that of the core section 1 is produced by using a common Vapor phase axial deposition apparatus (hereinafter called a VAD apparatus). The core section 1 is produced by depositioning particles of GeO₂ and that of SiO₂. The first cladding section 2 is produced by depositioning particles of SiO₂. Refractive index difference Δ of the core section 1 corresponding to the first cladding section 2 should preferably be 0.3 to 0.4%. A value of D/d which indicates a ratio of the diameter of the core section 1 (having diameter d) and the diameter of the first cladding section 2 (having diameter D) should preferably be more than 4.0. The reason why the value of D/d should preferably be such a value is as follows.

When a value of D/d is in a range of 4.0 to 4.8, it is possible to restrict an initial loss in the 1380 nm wavelength range to under 0.31 dB/km by restricting the OH concentration of the second cladding section 3 to under 0.1 ppm. When a value of D/d satisfies a condition such as D/d>4.8, it is possible to restrict a loss in the 1380 nm wavelength range to under 0.31 dB/km without performing dehydration using chlorine gas because there is little influence due to OH concentration in the second cladding section 3.

As explained above, if a loss in the 1380 nm wavelength range can be restricted to under 0.31 dB/km, it is possible to perform optical communications using a broader wavelength range.

However, if a value of D/d is under a condition of D/d<4.0, an initial loss in the 1380 nm wavelength range is larger than 0.31 dB/km even if the OH concentration of the second cladding section 3 is restricted to under 0.1 ppm; thus, it is impossible to achieve the objects of the present invention.

As explained above, it is preferable that a value of D/d indicating a ratio of a diameter D of the first cladding section 2 and a diameter d of the core section 1 should be in a range of 4.0 to 4.8, and that OH concentration of the core section 1, the first cladding section 2, and the second cladding section 3 should be under 0.1 ppm.

Otherwise, it is preferable that a value of D/d indicating a ratio of the diameter D of the first cladding section 2 and the diameter d of the core section 1 satisfy a relationship such as D/d>4.8, OH concentration of the core section 1, and the first cladding section 2 should be less than 0.1 ppm, and the OH concentration of the second cladding section 3 should be under 100 ppm.

After that, dehydration and sintering are performed on the porous soot so as to produce a glass rod. Here, if the value of D/d is 4.0 to 4.8, dehydration operation is performed in chlorine gas or in a mixed atmosphere of chlorine gas and oxygen gas. Also, a sintering operation is performed in an atmosphere of 1450° C. of helium gas.

A second cladding section 3 is formed by performing vapor phase deposition of SiO₂ particles on the outside of the above-mentioned glass rod. The thickness of the second cladding section 3 is determined according to that diameter in which the glass rod is formed. For example, if the diameter of an optical fiber is 125 μm, it is possible for outer vapor phase deposition of SiO₂ particles to be performed so that the thickness of the second cladding section 3 is 43 μm or less. When the thickness of the second cladding section 3 is thicker than 43 μm, this is not preferable because an initial loss in the 1380 nm wavelength range tends to become large.

If dehydration is necessary according to the value of D/d, the dehydration is performed in an atmosphere of chlorine gas or in a mixed atmosphere of chlorine gas and oxygen gas on a glass rod to which the vapor phase deposition of the second cladding section 3 is performed on the outside. Also, a sintering operation is performed in an atmosphere of helium gas at 1450° C. so as to form a glass preform.

Consequently, an optical fiber is formed by performing a drawing operation of the glass preform. If the drawing is fast, for example, if the drawing speed is 600 m/min or faster, the optical fiber cools immediately after the drawing operation. Therefore, it is preferable to use a drawing apparatus having an annealing device at an exit of the drawing furnace.

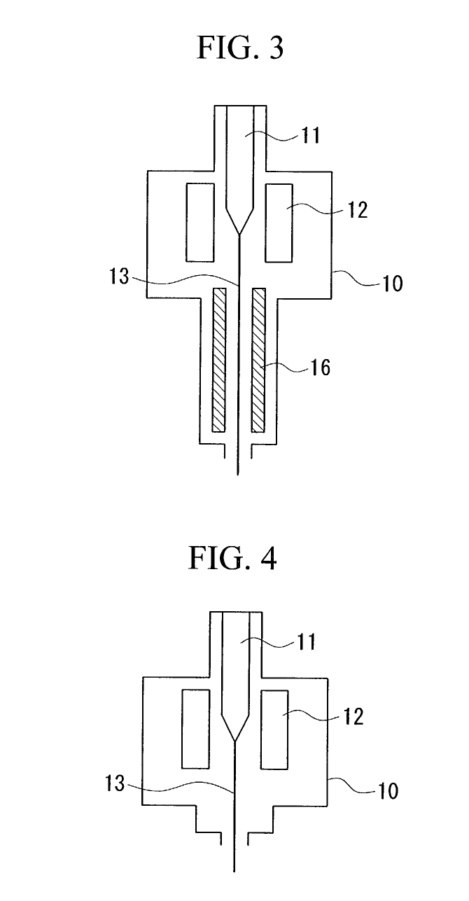

An example of a drawing apparatus which is used in this drawing process is shown in FIGS. 2 and 3.

In FIG. 2, reference numeral 10 indicates a drawing furnace. Drawing operation is performed on a glass preform 11 by a heater 12 in the drawing furnace 10 so as to form a bare optical fiber 13. After the bare optical fiber 13 is cooled in an annealing tube 14, a resin is applied to the bare optical fiber 13 by a resin applying apparatus so as to form an optical fiber strand. On a surface of the annealing tube 14, a gas introducing hole 15 is formed. For a cooling gas, it is possible to use an air, Ar, N₂, or mixture of any of these gases.

Also, a drawing apparatus shown in FIG. 3 is provided with a furnace with inclined heat zone 16 in place of the annealing tube 14 which is shown in FIG. 2 so as to cool the optical fiber core 13. Each reference numeral in FIG. 3 indicates the same structure which is indicated by the same reference numeral as shown in FIG. 2. It is preferable that the furnace with inclined heat zone 16 maintain a temperature at lower temperatures than a heater 12 in a unit of the drawing furnace 10, for example 400 to 1800° C. It is more preferable that the inclined furnace can vary temperatures according to zones thereinside.

In contrast, in FIG. 4, a conventional drawing furnace which does not have an annealing apparatus is shown. Each reference numeral in FIG. 4 indicates a structure having the same reference numeral shown in FIG. 2. If such a drawing furnace which does not have an annealing apparatus is used, the annealing effect is not sufficient, and SiO. tends to remain in the optical fiber. Therefore, the loss in the 1380 nm wavelength range tends to be higher after hydrogen diffusion.

After an optical fiber is produced by the above-mentioned method, the optical fiber is exposed to hydrogen gas under a partial pressure of 0.01 atm for ten days. After that, the loss after hydrogen diffusion is measured. If a loss in the 1380 nm wavelength range after hydrogen diffusion is 0.35 dB/km or less, there is no problem in performing optical communications using a broad wavelength range. However, if a loss in the 1380 nm wavelength range after hydrogen diffusion is higher than 0.35 dB/km, it is not possible to achieve the initial object of the present invention.

Examples of a single mode optical fiber produced by the above-mentioned manufacturing method are shown as follows.

### EXAMPLE 1

A glass preform was produced so that a D/d indicating a ratio of diameter d of a core section 1 and diameter D of a first cladding section 2 was 4.3, and the OH concentration of the second cladding section 3 was 0.1 ppm or less. After that, a single mode optical fiber was produced by drawing using a drawing apparatus having an annealing apparatus. A loss in the 1380 nm wavelength range was 0.285 dB/km. This value was lower than 0.31 dB/km; therefore, the loss in the 1380 nm wavelength range was satisfactory temporarily. Also, a loss in the 1380 nm wavelength range after the hydrogen test was measured. As a result, the loss was 0.320 dB/km. This value was less than 0.35 dB/km; therefore, the loss in the 1380 nm wavelength range was satisfactory as a final result in Example 1.

### EXAMPLE 2

A glass preform was produced so that a D/d indicating a ratio of diameter d of a core section 1 and diameter D of a first cladding section 2 was 4.9, and the OH concentration of the second cladding section 3 was 40 ppm or less. After that, a single mode optical fiber was produced by drawing using a drawing apparatus having an annealing apparatus. A loss in the 1380 nm wavelength range was 0.308 dB/km. This value was lower than 0.31 dB/km; therefore, the loss in the 1380 nm wavelength range was satisfactory temporarily. Also, a loss in the 1380 nm wavelength range after the hydrogen test was measured. As a result, the loss was 0.341 dB/km. This value was lower than 0.35 dB/km; therefore, the loss in the 1380 nm wavelength range was satisfactory as a final result in Example 2.

### Comparison Example 1

A glass preform was produced so that a D/d indicating a ratio of diameter d of a core section 1 and diameter D of a first cladding section 2 was 4.1, and the OH concentration of the second cladding section 3 was 0.1 ppm or less. After that, a single mode optical fiber was produced by drawing using a drawing apparatus which did not have an annealing apparatus. A loss in the 1380 nm wavelength range was 0.292 dB/km. This value was lower than 0.31 dB/km; therefore, the loss in the 1380 nm wavelength range was satisfactory temporarily. Also, a loss in the 1380 nm wavelength range after the hydrogen test was measured. However, as a result, the loss was 0.359 dB/km. This value was higher than 0.35 dB/km; therefore, the loss in the 1380 nm wavelength range was not satisfactory as a final result in Comparison Example 1.

### Comparison Example 2

A glass preform was produced so that a D/d indicating a ratio of the diameter d of a core section 1 and the diameter D of a first cladding section 2 was 3.8, and the OH concentration of the second cladding section 3 was 0.1 ppm or less. After that, a single mode optical fiber was produced by drawing using a drawing apparatus which did not have an annealing apparatus. A loss in the 1380 nm wavelength range was 0.320 dB/km. This value was higher than 0.31 dB/km; therefore, the loss in the 1380 nm wavelength range was not satisfactory temporarily. Also, a loss in the 1380 nm wavelength range after the hydrogen test was measured. However, as a result, the loss was 0.371 dB/km. This value was higher than 0.35 dB/km; therefore, the loss in the 1380 nm wavelength range was not satisfactory as a final result in Comparison Example 2.

### Comparison Example 3

A glass preform was produced so that a D/d indicating a ratio of diameter d of a core section 1 and diameter D of a first cladding section 2 was 4.3, and the OH concentration of the second cladding section 3 was 35 ppm. After that, a single mode optical fiber was produced by drawing using a drawing apparatus which did not have an annealing apparatus. A loss in the 1380 nm wavelength range was 0.317 dB/km. This value was higher than 0.31 dB/km; therefore, the loss in the 1380 nm wavelength range was not satisfactory temporarily. Also, a loss in the 1380 nm wavelength range after the hydrogen test was measured. However, as a result, the loss was 0.365 dB/km. This value was higher than 0.35 dB/km; therefore, the loss in the 1380 nm wavelength range was not satisfactory as a final result in Comparison Example 3.

TABLE 1 shows results which were obtained in the above-mentioned examples.

TABLE 1

| | | OH | | | | 1380 nm | |
|---|---|---|---|---|---|---|---|
| | | concen- | | | | Loss | |
| | | tration | | | | after | |
| | | in Second | 1380 | | | Hydrogen | |
| | | Clad | nm loss | Temporary | Annealing | Test | Final |
| | D/d | ppm | (dB/km) | Result | Apparatus | (dB/km) | Result |
| Example 1 | 4.3 | <0.1 | 0.285 | Satisfactory | provided | 0.320 | Satisfactory |
| Example 2 | 4.9 | 40 | 0.308 | Satisfactory | provided | 0.341 | Satisfactory |
| Comparison | 4.1 | <0.1 | 0.292 | Satisfactory | Not | 0.359 | Not |
| Example 1 | | | | | provided | | Satisfactory |
| Comparison | 3.8 | <0.1 | 0.320 | Not | Not | 0.371 | Not |
| Example 2 | | | | Satisfactory | provided | | Satisfactory |
| Comparison | 4.3 | 35 | 0.317 | Not | Not | 0.365 | Not |
| Example 3 | | | | Satisfactory | provided | | Satisfactory |

By the manufacturing method for a single mode optical fiber which is shown in the above-explained examples, a single mode optical fiber was manufactured by forming a glass preform 11 by performing vapor phase deposition of a second cladding section made from SiO₂ particles on an outer circumference of a glass rod comprising a core section 1 and a first cladding section 2, and performing drawing of the glass preform 11. By such a manufacturing method, it is possible to greatly reduce bubbles occurring in an interface between the core and the clad, or between the first cladding section 2 and the second cladding section 3. Also, it is easy to dehydrate the porous soot on which vapor phase deposition is performed; therefore, it is possible to produce an optical fiber while controlling OH concentration desirably.

Also, because a silica glass tube is not used, there is no influence such as bending of a silica glass tube which forms a core rod or a clad. Therefore, product yield increases, and it is possible to produce a single mode optical fiber at a low manufacturing cost.

Also, an optical fiber is manufactured so that a value of D/d such as a ratio of diameter D of the first cladding section 2 and diameter d of the core section 1 is in a range of 4.0 to 4.8, and the OH concentration of the core section 1, the first cladding section 2, and the second cladding section 3 is 0.1 ppm or less, a value of D/d such as a ratio of diameter of the first cladding section and a diameter of the core section is D/d>4.8, the OH concentration of the core section 1 and the first cladding section 2 are 0.1 ppm or less, and the OH concentration of the second cladding section 3 is 100 ppm or less. Therefore, it is possible to restrict an initial loss in the 1380 nm wavelength range to under 0.31 dB/km. Also, because the peak in the 1380 nm wavelength becomes small, it is possible to use both sides of the wavelength range for optical communications.

Also, because it is possible to restrict a loss in the 1380 nm wavelength range after hydrogen diffusion to under 0.35 dB/km, it is possible to supply a single mode optical fiber with a low loss in the 1380 nm wavelength range at a low manufacturing cost.

Also, it is possible to restrict generation of SiO. to low levels by performing drawing operation by a drawing apparatus having an annealing apparatus in a drawing process. Therefore, it is possible to supply a single mode optical fiber having a low loss in the 1380 nm wavelength range so as to be durable for use over long periods even if a hydrogen diffuses from the outside.

Also, an initial loss of the single mode optical fiber which is produced by the above-mentioned manufacturing method is 0.31 dB/km or less. Therefore, the peak in the 1380 nm wavelength range can be small, thus, it is possible to use both sides of the peak for optical communications. Also, it is possible to restrict the loss in the 1380 nm wavelength range after the hydrogen diffusion to 0.35 dB/km or less. Therefore, it is possible to perform optical communications in the 1380 nm wavelength range even if hydrogen diffusion occurs.

What is claimed is:

1. A manufacturing method for a single mode optical fiber, comprising steps of:
forming a glass rod having a core section and a first cladding section having a refractive index lower than that of the core section;
vapor phase depositing for a second cladding on the first cladding;
sintering the glass rod having the first and second claddings to produce a glass preform; and
performing the drawing operation on the glass preform to produce an optical fiber;
wherein the ratio of a diameter D of the first cladding section to the diameter d of the core section is in a range of 4.0 to 4.8; and OH concentrations of the core section, the first cladding section, and the second cladding section are 0.1 ppm or less.

2. A manufacturing method for a single mode optical fiber, comprising steps of:
forming a glass rod having a core section and a first cladding section having a refractive index lower than that of the core section;
vapor phase depositing for a second cladding on the first cladding;
sintering the glass rod having the first and second claddings to produce a glass preform; and
performing the drawing operation on the glass preform to produce an optical fiber;
wherein the ratio of the diameter of the first cladding section to the diameter of the core section is >4.8; the OH concentration of the core section and the first cladding section are not more than 0.1 ppm; and the OH concentration of the second cladding section is not more than 100 ppm.

3. A manufacturing method for a single mode optical fiber according to one of claims 1 and 2 wherein the initial loss in the 1380 nm wavelength range is not more than 0.31 dB/km and the loss in the 1380 nm wavelength range after hydrogen diffusion is not more than 0.35 dB/km.

4. A manufacturing method for a single mode optical fiber according to claim 3, wherein in the drawing process, the drawing operation is performed on the glass preform by using a drawing device having an annealing unit.

5. A manufacturing method for a single mode optical fiber according to claim 4 wherein the annealing unit comprises a furnace with inclined heat zone and an annealing tube.

6. A manufacturing method for a single mode optical fiber according to claim 5, wherein in the annealing unit, the annealing atmosphere is any one of an air, Ar, N₂, or mixture thereof.

7. A single mode optical fiber which is manufactured by a manufacturing method according to any one of claims 1 to 6.
